(19) United States
(12) Patent Application Publication
(10) Pub. No.: US 2012/0183647 A1
(43) Pub. Date: Jul. 19, 2012

(54) AQUATIC TURTLE FEEDING BLOCK

(76) Inventor: Gary Wayne Bagnall, San Luis Obispo, CA (US)

(21) Appl. No.: 13/008,412

(22) Filed: Jan. 18, 2011

(51) Int. Cl. A23K 1/175; A23K 1/16; A23K 1/18

(52) U.S. Cl. 426/72; 426/74; 426/648

(57) ABSTRACT

A solid aquatic food product for turtles made from a food grade Calcium sulfate hemihydrate base and various vitamins, minerals and/or nutrients. The block is used as a food source for turtles in aquatic habitats. In addition, a method of producing the product is disclosed.

### BACKGROUND OF THE INVENTION

1. Field of the Invention

The invention relates to an improved feeding product for use by turtles in aquatic habitats. More particularly, the invention relates to a turtle feed product that is usable in an aquatic environment, along with a method for producing the feed product.

2. Description of the Related Art

Many turtles live primarily in water and must eat their food in water. In nature, turtles eat a variety of foods to meet their nutritional requirements, and their natural diet cannot be easily replicated in captivity. This can result in vitamin, mineral, and nutrient deficiencies in the diets of captive aquatic turtles. Traditional vitamin and mineral supplements for reptiles come in powdered and liquid forms and cannot be used in an aquatic environment. The traditional forms will not work for aquatic turtles as the vitamin and mineral supplements will disperse in water and will not be ingested in sufficient quantities to be of any benefit to turtles. Additionally, if powdered or liquid forms are used they will alter the water chemistry of the environment which may be harmful to turtles. In captivity, aquatic turtles live in smaller volumes of water compared to their wild counterparts, and do not experience the broad stimulation they would get in their natural habitat. Essentially, they get bored in captivity.

When individuals leave turtles for long periods of time, they must make arrangements for the turtle to be fed while they are away. Currently available feeders mount above the aquatic habitat and drop food in the water at set intervals. The food often becomes moldy due to the humid environment associated with aquatic habitats.

It is an objective of the present invention to overcome the deficiencies of past feed products and provide a unique delivery mechanism for essential vitamins, minerals, and nutrients needed by aquatic turtles that can be directly added to water.

It is a further object of the present invention to provide a product that helps to prevent vitamin, mineral and nutrient deficiencies in turtles.

### SUMMARY OF THE INVENTION

The deficiencies of prior products are overcome by a solid aquatic turtle feed product that holds its shape long enough for turtles to eat the feeding block before it dissolves. Consequently, the turtle receives essential vitamins, minerals and nutritional supplements. The inventive aquatic solid feeding block contains a food grade calcium sulfate hemihydrate base component that has embedded therein the desired vitamins, minerals and nutritional supplements.

### DETAILED DESCRIPTION OF THE INVENTION

The inventive solid aquatic turtle feeding block contains a calcium sulfate hemihydrate base component and, if desired, essential vitamins, minerals, and nutritional supplements embedded therein. The present solid aquatic feeding block is produced by mixing aquatic turtle food pellets, vitamins, and minerals, with a calcium sulfate hemihydrate base, and then pouring the resulting mixture into a mold. The amounts and types of food, vitamins and minerals can be adjusted according to the nutritional requirements of various aquatic turtle species.

A preferred feeding block formulation is composed of the following:
Approximately 90% by weight food-grade calcium sulfate hemihydrate;
Approximately 9% by weight pelleted turtle food, whole food pieces, insects and/or dried vegetables;
Trace amounts of vitamins and minerals (natural or artificial flavors and colors may be added to alter appearance and scent of the blocks which may increase the palatability of the blocks and the feeding response of the turtles); and
Water added in an amount sufficient to create a wet calcium sulfate mixture.

The initial components are first mixed together with water creating a wet calcium sulfate mixture. The wet calcium sulfate mixture is then poured into molds and allowed to set long enough to allow the calcium sulfate mixture, now in the shape of feeding blocks, to harden so that they can be removed from the molds without breaking. The set time can vary depending on the nature of the calcium sulfate hemihydrate product used, but is typically less than one hour. After the shaped feeding blocks are removed from the molds, they are placed in an oven and dried until the desired moisture content is achieved, preferably, of approximately 18% moisture by weight.

The resulting shaped product is in the form of a solid aquatic turtle feeding block, which then is placed directly into water for feeding turtles in accordance with the present invention. Once placed within the water of the aquarium embodiment, the solid aquatic turtle feeding block holds its shape long enough to allow turtles to eat the feeding block before it dissolves, and consequently, the turtle receives beneficial nutrients, vitamins and minerals. The amount of time the feeding block will hold its shape depends upon the original size of the feeding block, the hardness of the water, and the pH of the water. If not immediately eaten by the turtles, the feeding block will slowly dissolve over a period of several hours to several days depending on water chemistry and the size of the feeding block.

As the feeding block dissolves, food pellets, whole food pieces, insects and/or dried vegetables are revealed and detached from the feeding block, allowing the turtles to forage and eat the exposed nutrients. When the exposed food pellets, whole food pieces, insects and/or dried vegetables are eaten, the turtle will also ingest a portion of the adjoining calcium sulfate block. Many turtles will not wait for the feeding block to dissolve, but will instead bite the feeding block to gain access to the food pellets, whole food pieces, insects and/or dried vegetables remaining as part of the feeding block. Regardless of the feeding method, the turtle receives the beneficial nutrients, vitamins and minerals from the feeding block.

Solid aquatic turtle feeding blocks can be made in a variety of forms and formulations depending on the nutritional requirements of various species, each are contemplated by the present invention, for example:
1. Calcium sulfate alone to provide Calcium Supplementation;
2. Calcium sulfate base with vitamins and other minerals added;
3. Calcium sulfate base with various food ingredients, vitamins and other minerals added.

The solid aquatic feeding block is produced by the following process:
Create a premix of dry ingredients. For example, and by way of example, the premix includes approximately 90% by weight food-grade calcium sulfate hemihydrate, approximately 9% by weight pelleted turtle food, whole food pieces, insects and/or dried vegetables, and trace amounts of vitamins and minerals. Natural or artificial flavors and colors may also be added to alter the appearance and scent of the feeding block which may increase the palatability of the feeding block and feeding response of the turtles.
Sufficient water is added to form a wet calcium sulfate hemihydrate mixture. The consistency is typically between 70 and 100 parts water to the calcium sulfate hemihydrate plaster by weight.
The wet calcium sulfate mixture is then poured into molds and allowed to set long enough to allow the wet calcium sulfate mixture to harden enabling the formed feeding blocks to be removed from the molds without breaking. The set time can vary depending on the nature of the calcium sulfate hemihydrate product used, but is typically less than one hour.
The feeding blocks are removed from the molds and the feeding blocks are placed in an oven to dry the wet Calcium sulfate mixture until the desired moisture level is achieved (less than approximately 18% moisture). The preferred range of moisture is from 8-18% by weight.

Various nutrients, supplements and vitamins such as Soybean meal, Wheat flour, Fish meal, Wheat middlings, Corn Gluten meal, Spirulina, Fish oil, Lecithin, Iron Oxide, Vitamin C, Dicalcium phosphate, Choline Chloride, Niacin, Thiamine Hydrochloride, d-Calcium Pantothenate, Pyridoxine Hydrochloride, Biotin, Beta Carotene, Vitamin E Supplement, Riboflavin, Thiamine Mononitrate, Folic Acid, Vitamin A Supplement, Vitamin D3 Supplement, Vitamin B12 Supplement, Manganese sulfate, Zinc Sulfate, Ferrous Sulfate, Copper Sulfate, Sodium Selenite, Potassium Iodate, Propionic Acid, dried fruit, dried vegetables, insects can be used alone or in combination. The list of nutrients, vitamins and minerals is merely representative of ingredients and other desired ingredients may be added as needed.

The product can be made of any desired shape including but not limited to blocks, fish shapes or star shapes.

The product provides environmental enrichment to aquatic turtles in the form of a different type of food source being offered. The nutritional supplement is a combination of food, calcium, minerals and vitamins. Enrichment is provided to the turtles as they investigate the solid aquatic turtle feeding block and work at getting the pellets embedded in the nutritious calcium solid aquatic turtle feeding block. Over time, the Calcium sulfate hemihydrate base dissolves and embedded components are exposed. The rate that the solid aquatic turtle feeding block dissolves depends on pH and hardness of the water. The turtles can feed on the components in addition to the Calcium sulfate hemihydrate base. For turtles that do not aggressively eat the solid aquatic turtle feeding block in a short period of time, the product can function as a vacation food service as food pellets are slowly exposed over a period of several days as the solid aquatic turtle feeding block dissolves. Uneaten Calcium will slowly dissolve and neutralize acidic water, which can be harmful to aquatic animals.

1. A solid turtle feeding block comprising:
a food grade calcium sulfate hemihydrate base wherein the feeding block has a moisture content ranging from 8-18% by weight.

2. The feeding block as claimed in claim 1, further comprising;
a compound selected from the group consisting of vitamins, minerals, nutrients, in a form of whole food items or food pellets, and combinations thereof.

3. The feeding block as claimed in claim 2, wherein the compound is embedded in the calcium sulfate hemihydrate base.

4. The feeding block of claim 2, wherein said calcium sulfate hemihydrate is approximately 90% by weight of the block.

5. The feeding block as claimed in claim 2, wherein said nutrients are present in amount of approximately 9% by weight of the block.

6. The feeding block as claimed in claim 2, wherein said block comprises approximately 90% by weight of the calcium sulfate hemihydrate; 9% by weight pelletized combination of vitamins, minerals and nutrients; trace food coloring and water.

7. A method of producing a turtle feeding block comprising the steps of:
adding a dry premix of nutrients, vitamins and minerals to a wet calcium sulfate hemihydrate to form a mixture;
pouring the mixture into a mold to form a desired shape;
allowing the mixture to set and dry to a desired hardness and a desired moisture content;
removing the mixture from the mold and placing the mixture into an oven for drying to a desired moisture content.

8. The method of claim 7, wherein the desired moisture content ranges from 8-18% by weight.

9. The method of claim 7, wherein the desired shape is a feeding block shape, fish shape or star shape.

10. The method of claim 7, wherein the block contains approximately 90% food-grade calcium sulfate hemihydrate; and 9% nutrients, vitamins and minerals.

11. The method of claim 7, wherein the nutrients are uniformly distributed in the mixture.

12. The method of claim 7 wherein the nutrients are food pellets, whole food pieces, insects or dried vegetables.
